(19) United States
(12) Patent Application Publication
(10) Pub. No.: US 2011/0197414 A1
(43) Pub. Date: Aug. 18, 2011

(54) SENSOR ARRANGEMENT AND METHOD FOR EASY INSTALLATION INTO A VEHICLE

(75) Inventors: Roland Burghardt, Frankfurt (DE); Bernhard Schmid, Friedberg (DE); Jörg Heimel, Ingelheim (DE); Roland Hilser, Kirchheim Teck (DE); Dirk Theobald, Eschborn (DE)

(73) Assignee: Continental Teves AG & Co. oHG, Frankfurt (DE)

(21) Appl. No.: 13/123,964

(22) PCT Filed: Oct. 8, 2009
(86) PCT No.: PCT/EP2009/063089

§ 371 Date: Apr. 13, 2011

(30) Foreign Application Priority Data
Oct. 17, 2008 (DE) 10 2008 052 194.9

(51) Int. Cl. B23Q 17/00; B23P 11/00

(52) U.S. Cl. 29/407.01; 29/428

(57) ABSTRACT

A method for installing a sensor arrangement into a vehicle having a vehicle chassis, wherein the vehicle chassis is in a defined position during the installation, and the sensor arrangement is attached directly or indirectly to the vehicle chassis, wherein the sensor arrangement includes one or more acceleration sensors with three linearly independent measuring directions, and the sensor arrangement has an electronic control unit which is configured in such a way that it includes a sensor calibration mode, wherein, after the attachment of the sensor arrangement, the at least one acceleration sensor senses the gravitational acceleration, after which the electronic control unit in the sensor calibration mode calculates and stores one or more relative positioning parameters from at least the detected direction of the gravitational acceleration (g), which positioning parameters include at least information about the relative positioning between the sensor arrangement and the vehicle chassis.

### CROSS REFERENCE TO RELATED APPLICATIONS

This application is the U.S. national phase application of PCT International Application No. PCT/EP2009/063089, filed Oct. 8, 2009, which claims priority to German Patent Application No. DE 10 2008 052 194.9, filed Oct. 17, 2008, the contents of such applications being incorporated herein by reference.

### FIELD OF THE INVENTION

The invention relates to a method for installing a sensor arrangement, a sensor arrangement, and to the use of the sensor arrangement in motor vehicles and other vehicles.

### BACKGROUND OF THE INVENTION

Hitherto it has been customary to install sensor arrangements for inertial variables such as, for example, for an ESP system, in a vehicle in such a way that they are oriented as precisely as possible and attached to two or more attachment points, in order to bring about sufficient measuring accuracy of acceleration variables and, in particular, of one or more rotational speeds, with respect to the movement of the vehicle chassis. The relative positioning between the sensor arrangement and vehicle chassis is of essential significance here for the measuring accuracy, wherein this relatively precise method of positioning and attachment is relatively costly.

Document DE 199 25 434 A1, which is incorporated by reference herein, proposes a method and a device for detecting the installation position of a navigation system in a vehicle. However, only acceleration sensors with two measuring directions which are linearly independent of one another are used here, as a result of which positioning inaccuracies cannot be detected and compensated with respect to all the degrees of freedom.

### SUMMARY OF THE INVENTION

The invention has an object of proposing a method for easily installing a sensor arrangement in a vehicle and a corresponding sensor arrangement.

This object is achieved according to the invention by a method for installing a sensor arrangement into a vehicle having a vehicle chassis, wherein the vehicle chassis is in a defined position during the installation, and the sensor arrangement is attached directly or indirectly to the vehicle chassis, wherein the sensor arrangement comprises one or more acceleration sensors with three linearly independent measuring directions, and the sensor arrangement has an electronic control unit which is configured in such a way that it comprises a sensor calibration mode, wherein, after the attachment of the sensor arrangement, the at least one acceleration sensor senses the gravitational acceleration, after which the electronic control unit in the sensor calibration mode calculates and stores one or more relative positioning parameters from at least the detected direction of the gravitational acceleration (g), which positioning parameters comprise at least information about the relative positioning between the sensor arrangement and the vehicle chassis.

This object is also achieved by a sensor arrangement for simple installation in a vehicle with a vehicle chassis, wherein the sensor arrangement comprises one or more acceleration sensors with three linearly independent measuring directions and an electronic control unit, wherein the electronic control unit is configured in such a way that it comprises a sensor calibration mode in which the gravitational acceleration is detected by means of the at least one acceleration sensor, after which one or more relative positioning parameters, which comprise at least one information item about the relative positioning between the sensor arrangement and the vehicle chassis, are calculated and stored on the basis of at least the detected direction of the gravitational acceleration.

In this method or this sensor arrangement, in particular on the one hand just one attachment axis/attachment point is necessary and, on the other hand, no further orientation of the housing of the sensor arrangement is necessary.

The attachment of the sensor arrangement is preferably carried out by means of at least one attachment device which is, in particular, part of a housing of the sensor arrangement.

The sensor arrangement preferably has a separate housing or is alternatively preferably integrated into an electronic control unit with a corresponding housing.

The attachment of the sensor arrangement in its own housing or in the housing of an electronic control unit in the vehicle is preferably carried out by screwing and/or latching, that is to say in a positively locking fashion, and/or bonding and/or by magnetic attachment, in particular combined with positively locking attachment.

In order to detect the acceleration with respect to the three linearly independent measuring axes, the sensor arrangement preferably has a three-dimensional-measuring acceleration sensor or alternatively preferably a combination of two or more single-dimensional-measuring or two-dimensional-measuring acceleration sensors.

The sensor arrangement is preferably not embodied as a navigation system but rather, in particular, as a sensor arrangement which makes available acceleration signals and/or rotational speed signals for a motor vehicle control system and correspondingly has at least one acceleration sensor and at least one rotational speed sensor.

It is preferred that during the installation of the sensor arrangement and/or during the sensor calibration mode, the vehicle chassis is oriented with its vehicle chassis floor plane or base plane and/or with the positioning plane on which the vehicle chassis is directly or indirectly positioned, essentially perpendicularly or at a defined angle with respect to the direction of the gravitational acceleration. In this case, the vehicle chassis is positioned on wheels in the positioning plane.

The sensor arrangement preferably comprises one or more rotational speed sensors, for the operation of which one or more calibration values, which are dependent, in particular, on the at least one relative positioning parameter, are calculated and/or stored in the sensor calibration mode. The position of the additional sensors in the vehicle can also be determined through knowledge of the relative position between additional sensors such as, for example, rotational speed sensors in the measurement system and the measurement system itself.

The at least one relative positioning parameter and/or calibration values are expediently embodied in the form of a transformation matrix or coordinate transformation matrix with which the measurement signals of the at least one acceleration sensor and/or rotational speed sensor are adapted, starting from a reference positioning within the vehicle, with respect to the actual positioning of the sensor arrangement within the vehicle.

The electronic control unit and/or the sensors are/is preferably part of the motor vehicle control system, in particular of an electronic motor vehicle brake system or of a vehicle chassis acceleration measurement system or of a shock absorber control system.

It is preferred that the installation of the sensor arrangement in the vehicle is carried out during a mounting process of the vehicle before the vehicle is actuated in the usual way, in particular before the termination of production of the corresponding vehicle, that is to say at or before the “end of the production line”, or in that the installation is carried out in the course of repair or maintenance of the sensor arrangement or in the course of replacement of the sensor arrangement.

The electronic control unit is preferably configured in such a way that the coordinates and/or position information of at least one attachment point and/or one attachment axis, to which the sensor arrangement is attached within the vehicle chassis, are stored in said electronic control unit, said attachment point being stored, in particular as a reference point, and in that these coordinates and/or this position information are/is used to directly or indirectly calculate the relative positioning parameters within the scope of the sensor calibration mode.

It is preferred that the sensor arrangement comprises one or more rotational speed sensors, and the electronic control unit is configured in such a way that one or more calibration values, which are dependent, in particular, on the at least one relative positioning parameter, are stored for the operation of the at least one rotational speed sensor in the sensor calibration mode.

The sensor arrangement is preferably embodied in such a way that the measuring directions of the at least one acceleration sensor are oriented essentially orthogonally with respect to one another.

The sensor arrangement expediently comprises one or more rotational speed sensors with one or more measuring axes, wherein the at least one rotational speed sensor is, in particular, arranged in such a way that the rotational speed about the vertical axis of the vehicle, that is to say the yaw rate, can be detected, and/or the rotational speed about the longitudinal axis and/or the transverse axis of the vehicle.

With respect to the installation of rotational speed sensors, the proposed sensor arrangement and the method are also advantageous in particular because hitherto the measuring axis for the detection of the yaw rate had to be oriented relatively precisely in the perpendicular direction with respect to the vehicle chassis floor plane, and the rotational speed sensor had to be installed correspondingly positioned with relatively high precision. On the basis of the calibration by means of the relative positioning parameters and/or of the at least one calibration value, deviations from this orientation can be compensated by the signal processing of the electronic control unit.

It is expedient that a measuring axis or measuring direction of the acceleration sensor and/or of the rotational speed sensor is parallel to an attachment axis, to which the sensor arrangement is attached and positioned in a defined fashion.

The at least one acceleration sensor is expediently embodied as a linear acceleration sensor.

The invention also relates to the use of the sensor arrangement in a motor vehicle, in particular a passenger car or truck or in a motor cycle or in an aircraft or in a boat or ship or in a rail vehicle.

### BRIEF DESCRIPTION OF THE DRAWINGS

Further preferred embodiments can be found in the following descriptions of exemplary embodiments with reference to figures.

In the drawings, in each case in a schematic illustration,

FIG. 1 shows an exemplary embodiment of a sensor arrangement with ideal orientation of the sensors, and

FIG. 2 shows an exemplary sensor arrangement with skewed orientation.

### DETAILED DESCRIPTION OF THE INVENTION

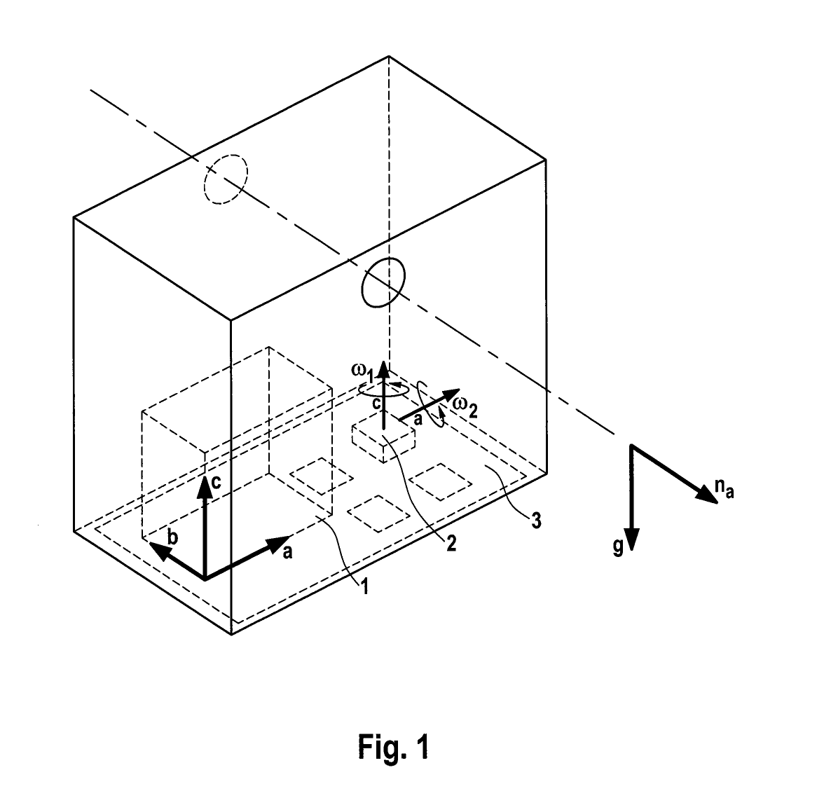

The exemplary sensor arrangement which is illustrated in FIG. 1 has an ideal orientation of the sensors 1, 2. In this context, the sensor arrangement comprises a 3-axis acceleration sensor 1, a 2-axis rotational speed sensor 2 and an electronic control unit 3, illustrated, for example, as a circuit board equipped with chips. The acceleration sensor within the sensor arrangement is arranged in such a way that the measuring direction b of the acceleration sensor 1 is oriented parallel to the attachment axis nₐ, and the measuring axis c of the acceleration sensor 1 is parallel to the gravitational acceleration g. The measuring axes a, c, about which the rotational speed sensor detects the rotational speeds ω1 and ω2 are also oriented parallel to the gravitational acceleration g and perpendicular to the gravitational acceleration as well as perpendicular to the attachment axis nₐ. The measuring axes of the acceleration sensor a, b, c are each embodied so as to be perpendicular with respect to one another.

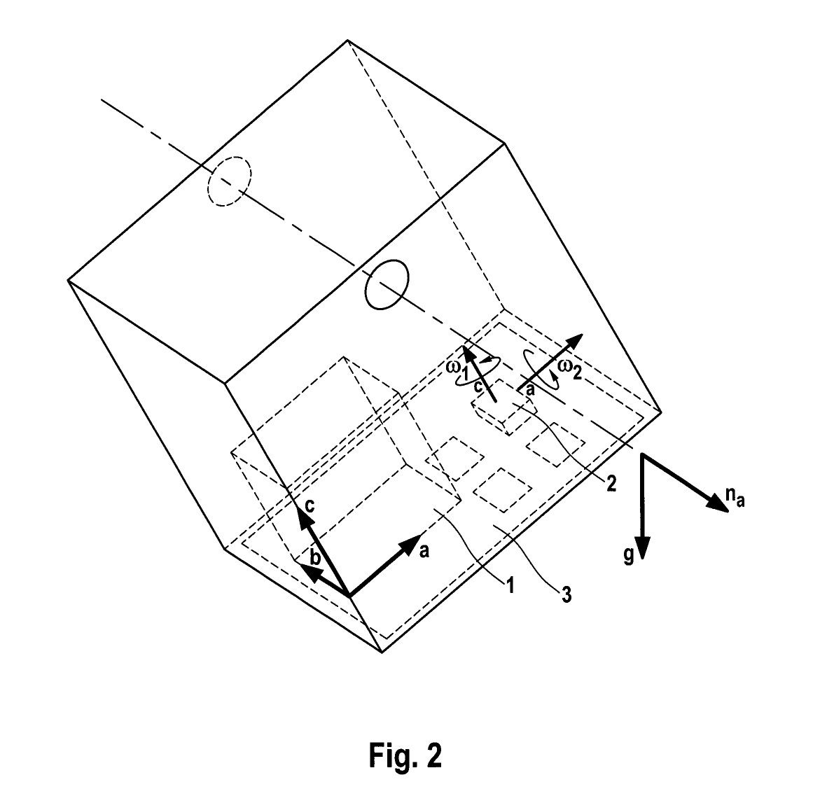

The attachment of the sensor arrangement which can be carried out in the vehicle, for example, by screwing, latching and bonding etc., can now, according to aspects of the invention, be carried out in any desired rotational position with respect to the attachment axis nₐ, as is illustrated by way of example in FIG. 2, wherein the attachment axis nₐ can again be oriented in the vehicle as desired, with the exception of a position parallel to the direction of the gravitational acceleration g, so that as a result of the direction of the gravitational acceleration g and the direction of the attachment axis nₐ the position in space is unambiguously defined with respect to the vehicle chassis.

For the sake of positioning, in particular just one attachment point is found necessary and furthermore essentially no further orientation of the sensor arrangement is necessary.

The sensor signals of the acceleration sensor and of the rotational speed sensor are calibrated, for example, by means of coordinate transformation parameters which influence the sensor signals in such a way as if they had been installed with an ideal installation position.

1.-10. (canceled)

11. A method for installing a sensor arrangement into a vehicle having a vehicle chassis, wherein the vehicle chassis is in a defined position during the installation, and the sensor arrangement is attached directly or indirectly to the vehicle chassis, wherein the sensor arrangement comprises one or more acceleration sensors with three linearly independent measuring directions, and the sensor arrangement has an electronic control unit which is configured in such a way that it comprises a sensor calibration mode, wherein, after the attachment of the sensor arrangement, the at least one acceleration sensor senses gravitational acceleration (g), after which the electronic control unit in the sensor calibration mode calculates and stores one or more relative positioning parameters from at least the detected direction of the gravitational acceleration (g), which positioning parameters comprise at least information about the relative positioning between the sensor arrangement and the vehicle chassis.

12. The method as claimed in claim 11, wherein during the installation of the sensor arrangement and/or during the sensor calibration mode, the vehicle chassis is oriented with a floor plane of the vehicle chassis and/or with a positioning plane on which the vehicle chassis is directly or indirectly positioned, substantially perpendicularly or at a defined angle with respect to the direction of the gravitational acceleration (g).

13. The method as claimed in claim 11, wherein the sensor arrangement comprises one or more rotational speed sensors, for the operation of which one or more calibration values, which are dependent on the at least one relative positioning parameter, are calculated and/or stored in the sensor calibration mode.

14. The method as claimed in claim 11, wherein the electronic control unit and/or the sensors are/is part of a motor vehicle control system.

15. The method as claimed in claim 11, wherein the electronic control unit and/or the sensors are/is part of an electronic motor vehicle braking system.

16. The method as claimed in claim 11, wherein the installation of the sensor arrangement in the vehicle is carried out (i) during a mounting process of the vehicle before termination of production of the corresponding vehicle, (ii) in the course of repair or maintenance of the sensor arrangement, or (iii) in the course of replacement of the sensor arrangement.

17. A sensor arrangement for simple installation in a vehicle with a vehicle chassis, according to the method as claimed in claim 11, wherein the sensor arrangement comprises one or more acceleration sensors with three linearly independent measuring directions and an electronic control unit, wherein the electronic control unit is configured in such a way that it comprises a sensor calibration mode in which the gravitational acceleration is detected by the at least one acceleration sensor, after which one or more relative positioning parameters, which comprise at least one information item about relative positioning between the sensor arrangement and the vehicle chassis, are calculated and stored on a basis of at least the detected direction of the gravitational acceleration.

18. The sensor arrangement as claimed in claim 17, wherein the electronic control unit is configured in such a way that coordinates and/or position information of at least one attachment point and/or one attachment axis (aₙ), to which the sensor arrangement is attached within the vehicle chassis, are stored in said electronic control unit, and in that the coordinates and/or the position information are/is used to directly or indirectly calculate the relative positioning parameters within a scope of the sensor calibration mode.

19. The sensor arrangement as claimed in claim 17, wherein the sensor arrangement comprises one or more rotational speed sensors, and the electronic control unit is configured in such a way that one or more calibration values, which are dependent on the at least one relative positioning parameter, are stored for operation of the at least one rotational speed sensor in the sensor calibration mode.

20. The sensor arrangement as claimed in claim 17, wherein the electronic control unit and/or the sensors is/are part of a motor vehicle control system.

21. The sensor arrangement as claimed in claim 17, wherein the electronic control unit and/or the sensors is/are part of an electronic motor vehicle braking system.

22. The use of the sensor arrangement as claimed in claim 17 in a motor vehicle, a passenger car, a passenger truck, an aircraft, a boat, a ship or a rail vehicle.
